(19) United States
(12) Patent Application Publication
(10) Pub. No.: US 2026/0339150 A1
(43) Pub. Date: Oct. 29, 2026

(54) FUNCTIONAL BACKPLANE AND LIGHT-EMITTING DEVICE

(71) Applicants: BOE MLED Technology Co., Ltd., Beijing (CN); BOE Technology Group Co., Ltd., Beijing (CN)

(72) Inventors: Lili WANG, Beijing (CN); Shanshan FENG, Beijing (CN); Chao LIU, Beijing (CN); Jing WANG, Beijing (CN); Mingming JIA, Beijing (CN); Huaimin WANG, Beijing (CN); Mengqing LIU, Beijing (CN); Jingping ZHAO, Beijing (CN); Ming ZHAI, Beijing (CN); Qi QI, Beijing (CN)

(21) Appl. No.: 18/841,525

(22) PCT Filed: Dec. 7, 2023
(86) PCT No.: PCT/CN2023/137076

§ 371 Date: Aug. 26, 2024

(51) Int. Cl. G02F 1/1335

(52) U.S. Cl. CPC G02F 1/133612

(57) ABSTRACT

The present application provides a functional backplane and a light-emitting device, relating to the field of display technology. The functional backplane includes a substrate, a plurality of electronic components, a plurality of connecting lines, and a bridge circuit structure. The bridge circuit structure includes a base, an adhesive layer disposed on a third surface of the base, and a line layer and a protective layer that are disposed on a fourth surface of the base. Each bridge line in the line layer is connected to a corresponding connecting line, thereby transmitting a driving signal provided by an external circuit structure to which the bridge line is connected to the electronic component via the connecting line.

The present application is a national stage of PCT application No. PCT/CN2023/137076, filed on Dec. 7, 2023, the entire contents of which are incorporated herein by reference.

### TECHNICAL FIELD

The present application relates to the field of display technology, and in particular, relates to a functional backplane and a light-emitting device.

### BACKGROUND

Light-emitting devices are now moving towards ultra-narrow bezels or even zero bezels to increase the screen-to-body ratio.

### SUMMARY

The present application provides a functional backplane and a light-emitting device. The technical solutions are as follows.

In an aspect, a functional backplane is provided. The functional backplane includes:
a substrate including a first surface and a second surface opposite to each other;
a plurality of electronic components disposed on the first surface of the substrate;
a plurality of connecting lines, wherein a first end of each of the connecting lines is disposed on the first surface of the substrate and connected to the electronic component, and a second end of each of the connecting lines is disposed on the second surface of the substrate; and
a bridge circuit structure including a base, an adhesive layer, a line layer, and a protective layer; wherein the base has a third surface and a fourth surface opposite to each other; the adhesive layer is disposed on the third surface of the base, and the adhesive layer is configured to bond the base to the second surface of the substrate; the line layer is disposed on the fourth surface of the base, and the line layer includes a plurality of bridge lines corresponding to the plurality of connecting lines, a first end of each of the bridge lines being connected to a second end of a corresponding connecting line, and a second end of each of the bridge lines being connected to an external circuit structure, so that driving signals provided by the external circuit structure are transmitted to the electronic component via the connecting line; and the protective layer is disposed on a side of the line layer away from the base.

Optionally, the second surface of the substrate is provided with at least one first alignment mark configured for structural alignment;
the base is provided with at least one first alignment opening corresponding to the at least one first alignment mark, wherein an orthographic projection of the first alignment opening on the substrate exposes the first alignment mark, and the orthographic projection of the first alignment opening on the substrate is not overlapped with orthographic projections of the plurality of bridge lines on the substrate.

Optionally, a distance h1 between an edge of the first alignment mark and an edge of the orthographic projection of the first alignment opening on the substrate ranges from 20 um to 1 mm;
a center of the first alignment mark is in a middle region of the orthographic projection of the first alignment opening on the substrate.

Optionally, the orthographic projection of the first alignment opening on the substrate is in the shape of a square, an ellipse, a circle or a regular polygon.

Optionally, a second surface of the base is provided with at least one second alignment mark configured for structural alignment;
the adhesive layer is provided with at least one second alignment opening corresponding to the at least one second alignment mark, wherein an orthographic projection of the second alignment mark on the substrate is within an orthographic projection of the second alignment opening on the substrate.

Optionally, a plurality of strip-shaped venting slots is formed in the adhesive layer; wherein the plurality of venting slots at least includes a first slot extending along a first direction and a second slot extending along a second direction, wherein the first direction is an extension direction of a portion of the connecting line disposed on the second surface, and the second direction is intersected with the first direction;
an orthographic projection of the first slot on the substrate and an orthographic projection of the second slot on the substrate are on a side, away from the first end of the bridge line, of the second end of the bridge line.

Optionally, the plurality of venting slots includes a plurality of first slots and one second slot, and the second direction is perpendicular to the first direction; wherein
the plurality of first slots is further away from the bridge line than the second slot, the plurality of the first slots is spaced apart from each other in the second direction, and a first end of each of the plurality of first slots is in communication with the second slot.

Optionally, a distance between a first side surface of the substrate and a second side surface of the base ranges from 0.5 mm to 5 mm; wherein
the first side surface of the substrate is a side surface of the substrate that is closest to a connecting portion between the first end of the connecting line and the second end of the connecting line, and the second side surface of the base is a side surface of the base that is closest to the first side surface of the substrate.

Optionally, an angle between the second side surface and the third surface of the base is an acute angle, and an orthographic projection of the fourth surface of the base on the third surface of the base is within the third surface of the base.

Optionally, the angle between the second side surface and the third surface ranges from 30° to 75°.

Optionally, the functional backplane further includes: a cushion layer structure disposed on a side, close to the first side surface of the substrate, of the second side surface of the base; wherein
an angle between a surface of the cushion layer structure close to the first side surface of the substrate and the third surface of the base is less than an angle between the second side surface of the base and the third surface of the base.

Optionally, the functional backplane further includes: a first connecting pad and a second connecting pad; wherein
the first connecting pad is disposed on the first surface of the substrate and is configured to connect the first end of the connecting line to the electronic component; and
the second connecting pad is disposed on the fourth surface of the base and is configured to connect the second end of the connecting line to the first end of the bridge line;
wherein a distance h3 between the second connecting pad and the second side surface of the base ranges from 100 μm to 0.5 mm.

Optionally, the bridge line includes a bridge portion between the first end and the second end; wherein
the protective layer is made of an insulative material, the protective layer is of a whole layer structure, and an orthographic projection of the protective layer on the base covers an orthographic projection of the bridge portion on the base and exposes orthographic projections of the first end and the second end of the bridge line on the base; or
the protective layer is made of an electrically conductive material, and the protective layer includes a plurality of protective patterns spaced apart from each other and corresponding to the plurality of bridge lines, wherein an orthographic projection of each of the plurality of protective patterns on the base covers an orthographic projection of a corresponding bridge line on the base.

Optionally, the base includes a flexible film layer; or
the base includes a first flexible film layer, a buffer layer, and a second flexible film layer stacked in sequence.

In another aspect, a light-emitting device is provided. The light-emitting device includes: a power supply assembly and the functional backplane as described in the above aspect; wherein
the power supply assembly is configured to supply power to the functional backplane.

### BRIEF DESCRIPTION OF DRAWINGS

For clearer descriptions of the technical solutions according to the embodiments of the present application, the following briefly introduces the accompanying drawings required for describing the embodiments. The accompanying drawings in the following descriptions show merely some embodiments of the present application, and persons of ordinary skill in the art may still derive other drawings from these accompanying drawings without creative effort.

FIG. 1 is a schematic structural diagram of a functional backplane according to an embodiment of the present application;

FIG. 2 is a schematic structural diagram of a bridge circuit structure according to an embodiment of the present application;

FIG. 3 is a schematic structural diagram of another functional backplane according to an embodiment of the present application;

FIG. 4 is a top view of a substrate and a base according to an embodiment of the present application;

FIG. 5 is a top view of a bridge circuit structure according to an embodiment of the present application;

FIG. 6 is a top view of an adhesive layer according to an embodiment of the present application;

FIG. 7 is a top view of another bridge circuit structure according to an embodiment of the present application;

FIG. 8 is a top view of another adhesive layer according to an embodiment of the present application;

FIG. 9 is a schematic view of a bridge circuit structure, a first protective film and a second protective film according to an embodiment of the present application;

FIG. 10 is a schematic view of another bridge circuit structure, another first protective film and another second protective film according to an embodiment of the present application;

FIG. 11 is a schematic diagram of yet another bridge circuit structure, yet another first protective film and yet another second protective film according to an embodiment of the present application;

FIG. 12 is a schematic diagram of a climb of a connecting line on a flexible printed circuit in a case that no cushion layer structure is provided according to an embodiment of the present application;

FIG. 13 is a schematic diagram of a climb of a connecting line on a flexible printed circuit in a case that a cushion layer structure is provided according to an embodiment of the present application;

FIG. 14 is a schematic diagram of a climb of a connecting line on a base in a case that no cushion layer structure is provided according to an embodiment of the present application;

FIG. 15 is a schematic diagram of a climb of a connecting line on a base in a case that no cushion layer structure is provided according to an embodiment of the present application;

FIG. 16 is a top view of a climb of a connecting line on a base in a case that no cushion layer structure is provided according to an embodiment of the present application;

FIG. 17 is a top view of a climb of a connecting line on a base in a case that a cushion layer structure is provided according to an embodiment of the present application;

FIG. 18 is a top view of a functional backplane according to an embodiment of the present application;

FIG. 19 is a sectional view of FIG. 18 along direction AA;

FIG. 20 is a top view of another functional backplane according to an embodiment of the present application; and

FIG. 21 is a sectional view of FIG. 20 along direction BB.

### DETAILED DESCRIPTION

In order to make the objectives, technical solutions and advantages of the present application clearer, the embodiments of the present application will be described in further detail below in conjunction with the accompanying drawings.

Some embodiments of the present application provide a light-emitting device. The light-emitting device includes a functional backplane, and may certainly include other components. For example, the light-emitting device includes a circuit for providing an electrical signal to the functional backplane to drive the functional backplane to emit light, and the circuit is referred to as a control circuit. For another example, the light-emitting device includes a circuit board and/or an integrated circuit (IC) electrically coupled to the functional backplane.

Optionally, the light-emitting device further includes a power supply assembly, which is configured to supply power to the functional backplane.

In some embodiments, the light-emitting device is an illumination device. The light-emitting device is used as a light source to achieve an illumination function. For example, the light-emitting device is a backlight module in a liquid crystal display device, a lamp used for internal or external illumination, various signal lamps, etc.

In some other embodiments, the light-emitting device is a display device. In this case, the functional backplane is a display substrate for achieving an image (i.e., screen) display function. The light-emitting device includes a display or a product including a display. The display may be a flat panel display (FPD), a microdisplay, or the like. The displays are divided into transparent displays and non-transparent displays according to whether the back side of the display is visible to users, and are divided into flexible displays and normal displays (which may be referred to as rigid displays) according to whether the display is bendable or curlable. For example, products including a display includes: a computer display, a television, a billboard, a laser printer with a display function, a telephone, a phone, a personal digital assistant (PDA), a laptop computer, a digital camera, a portable camcorder, a viewfinder, a vehicle, a large-area wall, a screen in a theater, a stadium sign, and the like.

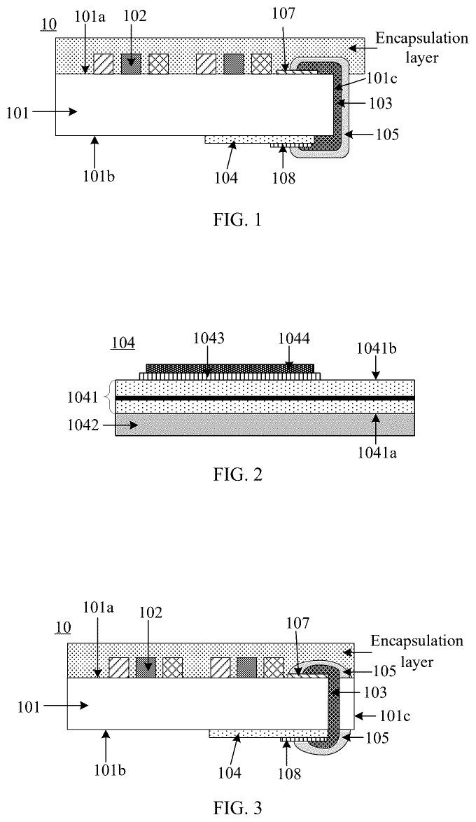

Some embodiments of the present disclosure provide a functional backplane. As shown in FIG. 1, the functional backplane includes a substrate and at least one electronic component disposed on the substrate. The electronic component may be a micro light-emitting diode, a micro IC chip, a micro sensor, a micro driver, and the like, which is not limited herein.

In some embodiments, taking the electronic component being a micro light-emitting diode as an example, the functional backplane is used as a backlight source or a display device. In the case that the functional backplane is used as a backlight source, the functional backplane is paired with a passive display panel, i.e., a liquid crystal display panel (LCD), to achieve a full-color screen display. In this case, the functional backplane as a whole emits monochromatic light or polychromatic light (e.g., white light), and by arranging a plurality of micro light-emitting diodes in a matrix and in combination with the local dimming technology, finer brightness control and higher color contrast can be achieved. In the case that the functional backplane is used as a display device, a micro light-emitting diode capable of emitting different colors of light is provided on the functional backplane, and the functional backplane cooperates with the micro light-emitting diode to achieve the full-color screen display, which has higher brightness and contrast.

At present, in consideration of the process yield and manufacturing cost, when large-size products are manufactured, a plurality of functional backplanes are spliced. In order to avoid a split feeling between adjacent functional backplanes due to splicing, which affects user experience, the functional backplanes are designed to have ultra-narrow bezels or even zero bezels so as to present seamless splicing effects, which is the direction of development in the field.

The micro light-emitting diode display technology is recognized as a very promising third-generation display technology, and can achieve an infinite size display more easily using the small-size splicing technology. The micro LED display may be, for example, a micro LED or a mini LED.

In order to achieve an ultra-narrow bezel display, an external circuit structure is provided on a back side of the substrate, and an electronic component disposed on a front side of the substrate and the external circuit structure disposed on the back side of the substrate are connected by a connecting line (disposed on a side surface of the substrate).

FIG. 1 is a schematic structural diagram of a functional backplane according to an embodiment of the present application. Referring to FIG. 1, the functional backplane 10 includes a substrate 101, a plurality of electronic components 102, a plurality of connecting lines 103, and a bridge circuit structure 104. The substrate 101 has a first surface 101a and a second surface 101b opposite to each other, and the plurality of electronic components 102 are disposed on the first surface 101a of the substrate 101. A first end of each connecting line 103 is disposed on the first surface 101a of the substrate 101 and is connected to the electronic component 102; and a second end of each connecting line 103 is disposed on the second surface 101b of the substrate 101.

FIG. 2 is a schematic structural diagram of a bridge circuit structure according to an embodiment of the present application. Referring to FIG. 2, the bridge circuit structure 104 includes a base 1041, an adhesive layer 1042, a line layer 1043, and a protective layer 1044. The base 1041 has a third surface 1041a and a fourth surface 1041b opposite to each other. The adhesive layer 1042 is disposed on the third surface 1041a of the base 1041, and the adhesive layer 1042 is configured to bond the base 1041 to the second surface 101b of the substrate 101. The line layer 1043 is disposed on the fourth surface 1041b of the base 1041, and the line layer 1043 includes a plurality of bridge lines (not shown in the figure) corresponding to the plurality of connecting lines 103. A first end of each bridge line is connected to the second end of the corresponding connecting line 103, and a second end of the bridge line is connected to an external circuit structure, so that driving signals provided by the external circuit structure are transmitted to the electronic component 102 via the connecting line 103. The protective layer 1044 is disposed on the side of the line layer 1043 away from the base 1041, and an orthographic projection of the protective layer 1044 on the base 1041 covers at least a portion of the line layer 1043, for protecting at least the portion of the line layer 1043.

In the embodiments of the present application, the base 1041 mainly functions to bear the bridge lines. After the base 1041 is adhered to the second surface 101b of the substrate 101 by the adhesive layer 1042, the connecting lines 103 are formed by film coating or printing, thereby achieving an effective connection between the electronic component 102 and the bridge lines.

Referring to FIG. 1, the connecting line 103 includes portions sequentially provided on the first surface 101a, the first side surface 101c, and the second surface 101b. Alternatively, referring to FIG. 3, the substrate 101 is provided with a through hole, and the connecting line 103 extends from the first surface 101a to the second surface 101b through the through hole. In both the embodiment illustrated in FIG. 1 and the embodiment illustrated in FIG. 3, the bridge circuit structure 104 may be provided on the second surface 101b, and the connecting line 103 is connected to the bridge line in the bridge circuit structure 104.

In combination with FIG. 1 and FIG. 2, the fourth surface 1041b of the base 1041 is further away from the substrate 101 than the third surface 1041a is, and the line layer 1043 is disposed on the side of the base 1041 away from the substrate 101. Therefore, in order to connect the connecting line 103 to the bridge line in the line layer 1043, the connecting line 103 needs to climb up the side surface of the base 1041 to the surface of the base 1041 away from the substrate 101, such that the second end of the connecting line 103 is connected to the bridge line on the fourth surface 1041b of the base 1041, thereby achieving signal transmission.

In the embodiments of the present application, the bridge lines in the bridge circuit structure 104 are prepared by an exposure process. The precision of the exposure process is high and stable, and bridge lines with a smaller line width and line spacing can be prepared. Thus, the widths occupied by the end portions of all bridge lines can be limited to a smaller size range. Furthermore, in the case where a flexible printed circuit (FPC) is used for connection to an external circuit structure, a flexible printed circuit with a smaller width can be used, which can improve the design flexibility and reduce the cost.

In summary, the embodiments of the present application provide a functional backplane, including a substrate, a plurality of electronic components, a plurality of connecting lines, and a bridge circuit structure. The bridge circuit structure includes a base, an adhesive layer disposed on the third surface of the base, and a line layer and a protective layer that are disposed on the fourth surface of the base. Each bridge line in the line layer is connected to the corresponding connecting line, thereby transmitting the driving signal provided by the external circuit structure to which the bridge line is connected to the electronic component via the connecting line. According to the solution in the embodiments of the present application, the widths occupied by the end portions of all bridge lines are limited to a smaller size range, and thus there is no need to bond a larger number of flexible printed circuits for connection to the external circuit structure. Therefore, the flexibility is higher.

In the embodiments of the present application, the connecting lines 103 and the bridge lines are all metal lines. The metal line is made of a material with a three-layer stacked structure of Ti (titanium), Al (aluminum), and Ti, denoted as Ti/Al/Ti. Alternatively, the metal line is made of a material with a three-layer stacked structure of Mo (molybdenum), Al, and Mo, denoted as Mo/Al/Mo. Alternatively, the metal line is made of a material with a three-layer stacked structure of Ti, Cu (copper), and Ti, denoted as Ti/Cu/Ti. Alternatively, the metal line is made of a material with a three-layer stacked structure of Mo, Cu, and Mo, denoted as Mo/Cu/Ti. Alternatively, the metal line is made of a material with a three-layer stacked structure MoNb (molybdenum-niobium alloy), Al, and MoNb, denoted as MoNb/Al/MoNb. Alternatively, the metal line is made of a material with a three-layer stacked structure of MoNb, Cu, and MoNb, denoted as MoNb/Al/MoNb. Alternatively, the metal line is made of a material with a three-layer stacked structure of MoNb, Cu, and MoNb, denoted as MoNb/Cu/MoNb. The metal line may also be made of other materials, which is not limited in the embodiments of the present application.

Optionally, the thickness of the metal line needs to be measured and designed according to the product performance or users' needs, and generally, the thickness of the metal line ranges from 0.5 μm (micron) to 2 μm.

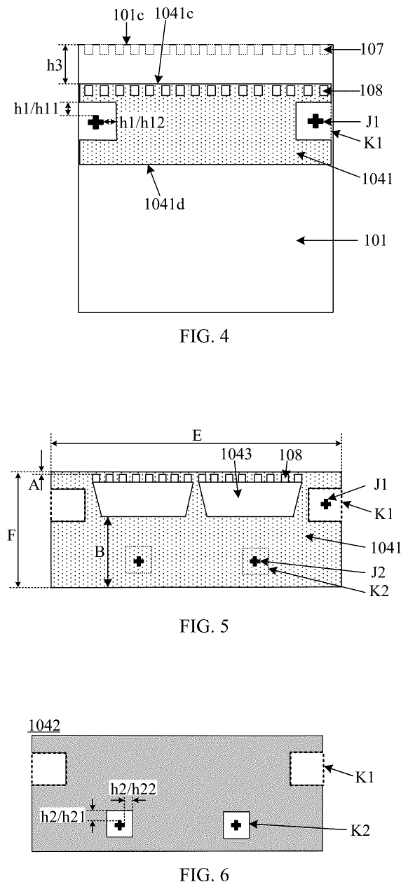

FIG. 4 is a top view of a substrate and a base according to an embodiment of the present application. Referring to FIG. 4, the second surface 101b of the substrate 101 is provided with at least one first alignment mark J1 (two first alignment marks J1 are shown in FIG. 4), and the first alignment mark J1 is used for structural alignment. For example, the first alignment mark J1 is used for alignment of the substrate 101 and the bridge circuit structure 104 when they are bonded.

The first alignment mark J1 needs to be recognized in order to function, and the first alignment mark J1 cannot be recognized if the first alignment mark J1 is covered by the base 1041. Therefore, alignment openings need to be formed at positions corresponding to the first alignment mark J1 in the base 1041 and adhesive layer 1042 of the bridge circuit structure 104. Referring to FIG. 4, the bridge circuit structure 104 has at least one first alignment opening K1 corresponding to the at least one first alignment mark J1. An orthographic projection of the first alignment opening K1 on the substrate 101 exposes the first alignment mark J1. In addition, the orthographic projection of the first alignment opening K1 on the substrate 101 is not overlapped with the orthographic projections of the plurality of bridge lines on the substrate 101, which can ensure that the bridge lines can be normally routed on the base 1041.

Optionally, the distance h1 between the edge of the first alignment mark J1 and the edge of the orthographic projection of the first alignment opening K1 on the substrate 101 ranges from 20 μm to 1 mm, which can ensure that the first alignment opening K1 can completely expose the first alignment mark J1 and ensure that the first alignment mark J1 can be the recognized effectively. The distance h1 ranging from 20 μm to 1 mm refers to that the distance hl is greater than or equal to 20 μm and less than or equal to 1 mm, i.e., 20 μm≤h1≤1 mm.

Exemplarily, referring to FIG. 4, the first alignment mark J1 is of a cross structure, and the edge of the first alignment mark J1 is an end portion of a branch of the cross structure. The distance h1 between the edge of the first alignment mark J1 and the edge of the orthographic projection of the first alignment opening K1 on the substrate 101 refers to the distance between the end portion of the branch and the edge of the orthographic projection of the first alignment opening Kl on the substrate 101. Certainly, the first alignment mark J1 may also be of other shapes.

Optionally, the cross structure includes two branches perpendicular to each other, the distance h11 between a first branch of the two branches and a first edge of the first alignment opening K1 is equal to the distance h12 between a second branch of the two branches and a second edge of the first alignment opening K1. An extension direction of the first branch is perpendicular to the first edge, and an extension direction of the second branch is perpendicular to the second edge.

Certainly, the distance h11 between the first branch and the first edge of the first alignment opening K1 may be not equal to the distance h12 between the second branch and the second edge of the first alignment opening K1, which is not limited in the embodiments of the present application.

Exemplarily, in the case that the distance hl between the end portion of either branch and the edge of the orthographic projection of the first alignment opening K1 on the substrate 101 is greater than or equal to 0.5 mm, the distance h11 between the first branch and the first edge of the first alignment opening K1 is not equal to the distance h12 between the second branch and the second edge of the first alignment opening K1.

In the embodiments of the present application, the center of the first alignment mark J1 is in a middle region of the orthographic projection of the first alignment opening K1 on the substrate 101. In this way, the size of the first alignment opening K1 can be reduced as much as possible on the premise that the first alignment mark J1 is completely exposed, thereby avoiding the routing of the bridge lines from be affected.

Optionally, the orthographic projection of the first alignment opening K1 on the substrate 101 is in the shape of a regular polygon, an ellipse, a circle, or the like. The regular polygon may be a square, a regular pentagon, a regular hexagon, or the like. For example, referring to FIG. 4, the orthographic projection of the first alignment opening K1 on the substrate 101 is in the shape of a square. Certainly, the orthographic projection of the first alignment opening K1 on the substrate 101 may be in other shapes, which is not limited in the embodiments of the present application.

FIG. 5 is a partial top view of a bridge circuit structure according to an embodiment of the present application. Referring to FIG. 5, the second surface 101b of the base 1041 is provided with at least one second alignment mark J2 (two second alignment marks J2 are shown in FIG. 5), and the second alignment mark J2 is used for structural alignment. For example, the second alignment mark J2 is used for alignment of the substrate 101 and the bridge circuit structure 104 when they are bonded.

Generally, since bubbles and textures in the adhesive layer 1042 disposed on the side of the base 1041 close to the substrate 101 affect the recognition of second alignment mark J2, the second alignment opening K2 is formed at a position corresponding to the second alignment mark J2 in the adhesive layer 1042 to ensure the effect of recognizing the second alignment mark J2. Referring to FIG. 6, the adhesive layer 1042 is provided with at least one second alignment opening K2 corresponding to the at least one second alignment mark J2, and the orthographic projection of the second alignment mark J2 on the substrate 101 is within the orthographic projection of the second alignment opening K2 on the substrate 101.

Optionally, the distance h2 between an edge of the second alignment mark J2 and an edge of the orthographic projection of the second alignment opening K2 on the substrate 101 ranges from 20 μm to 1 mm, which can ensure that there is no material of the adhesive layer 1042 underneath the second alignment mark J2 at all, thereby avoiding the recognition of the second alignment mark J2 from being affected due to bubbles or textures on the surface of the adhesive layer 1042 when the adhesive layer 1042 is bonded. The distance h2 ranging from 20 um to 1 mm refers to that the distance h2 is greater than or equal to 20 μm and less than or equal to 1 mm, i.e., 20 μm≤h2≤1 mm.

Exemplarily, referring to FIG. 6, the second alignment mark J2 is of a cross structure, and the edge of the second alignment mark J2 is an end portion of a zigzag branch of the cross structure. The distance h2 between the edge of the second alignment mark J2 and the edge of the orthographic projection of the second alignment opening K2 on the substrate 101 refers to the distance between the end portion of the branch and the edge of the orthographic projection of the second alignment opening K2 on the substrate 101. Certainly, the second alignment mark J2 may also be in other shapes.

Optionally, the cross structure includes two branches perpendicular to each other, and the distance h21 between a first branch of the two branches and a third edge of the second alignment opening K2 is equal to the distance h22 between a second branch of the two branches and a fourth edge of the second alignment opening K2. The extension direction of the first branch is perpendicular to the third edge, and the extension direction of the second branch is perpendicular to the fourth edge.

Certainly, the distance h21 between the first branch and the third edge of the second alignment opening K2 may not be equal to the distance h22 between the second branch and the fourth edge of the second alignment opening K2, which is not limited in the embodiments of the present application.

Exemplarily, in the case that the distance h2 between the end portion of either branch and the edge of the orthographic projection of the second alignment opening K2 on the substrate 101 is greater than or equal to 0.5 mm, the distance h21 between the first branch and the third edge of the second alignment opening K2 is not equal to the distance h22 between the second branch and the fourth edge of the second alignment opening K2.

In the embodiments of the present application, the center of the second alignment mark J2 is in a middle region of the orthographic projection of the second alignment opening K2 on the substrate 101. In this way, the size of the second alignment opening K2 can be reduced as much as possible on the premise of ensuring that there is no material of the adhesive layer 1042 underneath the second alignment opening K2, thereby avoiding the bonding effect of the adhesive layer 1042 from be affected.

Referring to FIG. 6, the orthographic projection of the second alignment opening K2 on the substrate 101 is in the shape of a square. Certainly, the orthographic projection of the second alignment opening K2 on the substrate 101 may also be in other shapes, e.g., in the shape of an ellipse, a circle, a regular polygon, or the like, which is not limited in the embodiments of the present application.

Generally, in the process of manufacturing the functional backplane 10, the functional backplane 10 is subjected to a number of high temperature treatments after the bridge circuit structure 104 and the substrate 101 are bonded. However, during the high temperature treatments of the functional backplane 10, there is a big difference between the coefficient of thermal expansion of the adhesive layer 1042 and the coefficient of thermal expansion of the base 1041, which may easily result in warpages of the functional backplane.

Optionally, after the bridge circuit structure 104 and the substrate 101 are bonded, the adhesive layer 1042 needs to be cured at a temperature of 150 °C. After the connecting line 103 is formed, the material of the connecting line 103 needs to be cured at a temperature of 200 °C or lower (the temperature of 200 °C or lower facilitates a stable production). For example, assuming that the material of the connecting line 103 is a mixture of silver powder and resin, then the material of the connecting line 103 is cured at a temperature of 150 °C for a duration of 30 minutes. After a line protective layer 105 for protecting the connecting line 103 is formed, the line protective layer 105 needs to be cured at a temperature of 200 °C or lower (the temperature of 200 °C or lower facilitates a stable production). For example, assuming that the material of the line protective layer 105 is epoxy resin, the material of the line protective layer 105 is cured at a temperature of 150 °C for a duration of 30 minutes. The fixed connection of the electronic component 102 and the substrate 101 needs to be achieved by a die bond process at a temperature of 270 °C.

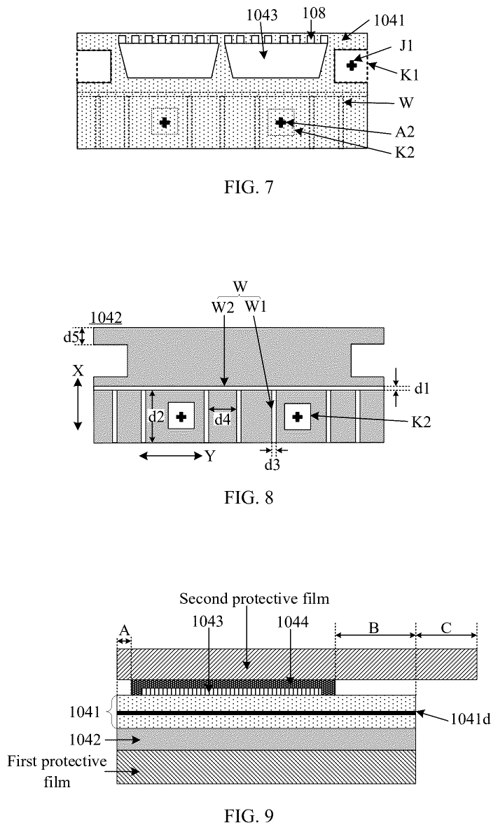

In order to solve the problem of warping of the functional backplane 10, a material with better temperature resistance is selected as the material of the adhesive layer 1042. Better temperature resistance means less expansion at a high temperature (e.g., 270 °C). Alternatively, a plurality of strip-shaped venting slots W as shown in FIG. 7 and FIG. 8 are further formed in the adhesive layer 1042. During the high temperature treatment later, the venting slots W can provide expansion space for the expansion of the adhesive layer 1042 to accommodate a part of the adhesive layer 1042, thereby avoiding the functional backplane from warping due to a large difference in the expansion volume of the adhesive layer 1042 and the expansion volume of the base 1041, and ensuring the yield of the functional backplane.

Referring to FIG. 8, the plurality of venting slots W at least include a first slot W1 extending along a first direction X and a second slot W2 extending along a second direction Y. The first direction X is an extension direction of the portion of the connecting line 103 disposed on the second surface 101b, and the second direction Y is intersected with the first direction X. For example, the second direction Y is perpendicular to the first direction X. Orthographic projections of the first slot W1 and the second slot W2 on the substrate 101 are on a side, away from the first end of the bridge line, of the second end of the bridge line.

Furthermore, referring to FIG. 8, the plurality of venting slots W include a plurality of first slots W1 and one second slot W2. The plurality of first slots W1 are further away from the bridge line than the second slot W2 is. The plurality of first slots W1 are spaced apart from each other in the second direction Y, and the first end of each first slot W1 is in communication with the second slot W2.

Generally, the functional backplane 10 is more likely to warp in the second direction Y. Therefore, by designing the plurality of first slots W1 extending along the first direction X and arranged along the second direction Y, as much expansion space as possible can be provided for the expansion of the adhesive layer 1042 in the second direction Y, and the total amount of expansion of the adhesive layer 1042 in the second direction Y can be reduced, thereby reducing the possibility that the functional backplane warps in the second direction Y.

Optionally, the length of the second slot W2 (the length of the second slot W2 along the second direction Y) is equal to the length of the bridge circuit structure 104 in the second direction Y, and the width d1 of the second slot W2 (the length of the second slot W2 along the first direction X) ranges from 1 mm to 3 mm. The distance d2 between the second slot W2 and the edge of the bridge circuit structure 104 away from the connecting line 103 ranges from 5 mm to 15 mm.

Optionally, the first slot W1 extends from the position of the second slot W2 along a direction going away from the connecting line 103 to the edge of the bridge circuit structure 104, i.e., the length d2 of the first slot W1 (the length of the first slot W1 along the first direction X) is equal to the distance between the second slot W2 and the edge of the bridge circuit structure 104 away from the connecting line 103. The width d3 of the first slot W1 (the length of the first slot W1 along the second direction Y) ranges from 1 mm to 3 mm. The distance d4 between adjacent first slots W1 ranges from 2 mm to 6 mm. In addition, the ratio of d4 to d3 is greater than or equal to 1.5 and is less than or equal to 3, i.e., 1.5≤d4/d3≤3.

Furthermore, the distance d5 between the side surface 1042a of the adhesive layer 1042 away from the venting slot W and the first alignment opening K1 along the first direction X is greater than or equal to 2 mm, which can ensure the bonding effect of the adhesive layer 1042.

Optionally, the thickness of the adhesive layer 1042 ranges from 20 μm to 100 μm, i.e., the thickness of the adhesive layer 1042 is greater than or equal to 20 μm and less than or equal to 100 μm. That is, the adhesive layer 1042 cannot be too thin or too thick. If the adhesive layer 1042 is too thin, the bonding effect between the base 1041 and the substrate 101 cannot be ensured; and if the adhesive layer 1042 is too thick, the total thickness of the adhesive layer 1042 and the base 1041 is too large, that is, the climbing height of the connecting line 103 is too big and the yield of the connecting line 103 is low.

In the embodiments of the present application, referring to FIG. 4, the distance h3 between the first side surface 101c of the substrate 101 and the second side surface 1041c of the base 1041 ranges from 0.5 mm to 5 mm. The first side surface 101c of the substrate 101 is a side surface of the substrate 101 that is closest to a connecting portion between the first end and the second end of the connecting line 103, and the second side surface 1041c of the base 1041 is a side surface of the base 1041 that is closest to the first side surface 101c of the substrate 101. The distance h3 ranging from 0.5 mm to 5 mm refers to that the distance h3 is greater than or equal to 0.5 mm and is less than or equal to 5 mm. i.e., 0.5 mm≤h3≤5 mm.

Exemplarily, in FIG. 1, the first side surface 101c of the substrate 101 is a side surface around which the connecting portion of the connecting line 103 is wound. In FIG. 3, the first side surface 101c of the substrate 101 is a side surface closest to the through hole.

Since the second end of the connecting line 103 needs to be provided on the second surface 101b of the substrate 101 and climb along the second side surface 1041c of the base 1041, the distance between the first side surface 101c of the substrate 101 and the second side surface 1041c of the base 1041 is designed to be greater than or equal to 0.5 mm, which can provide a buffer region for routing of the connecting line 103, and avoid the connecting line 103 from climbing in a short distance, thereby ensuring the yield of the connecting line 103. Additionally, the distance between the first side surface 101c of the substrate 101 and the second side surface 1041c of the base 1041 is less than or equal to 5 mm, which can avoid the resistance of the connecting line 103 being too large due to the big distance, thereby improving the signal transmission effect.

Additionally, since the distance h3 between the first side surface 101c of the substrate 101 and the second side surface 1041c of the base 1041 is not a fixed value, the first alignment opening K1 is not formed at a fixed position the position in the base 1041. Therefore, before the first alignment opening K1 is formed in the base 1041, the distance h3 between the first side surface 101c of the substrate 101 and the second side surface 1041c of the base 1041 is determined first, and then the first alignment opening K1 is formed at a specific position on the premise that the first alignment opening K1 exposes the first alignment mark J1. Optionally, the center of the first alignment mark J1 is in the middle region of the orthographic projection of the first alignment opening K1 on the substrate 101.

In the embodiments of the present application, referring to FIG. 9, before the bridge circuit structure 104 and the substrate 101 are bonded, a first protective film is formed on the side, away from the base 1041, of the adhesive layer 1042 of the bridge circuit structure 104. The first protective film can bear and protect the adhesive layer 1042, to avoid foreign matters from appearing in the adhesive layer 1042 before the bridge circuit structure 104 and the substrate 101 are bonded, thereby ensuring the bonding effect of the adhesive layer 1042.

Optionally, the thickness of the first protective film is greater than 50 μm, such that the first protective film has a certain support performance, thereby ensuring the effect of bearing the adhesive layer 1042. In addition, in order to ensure that the first protective film is not separated from the adhesive layer 1042 before the bridge circuit structure 104 and the substrate 101 are bonded, the following condition needs to be satisfied: the adhesive force of the first protective film is greater than 5 gf/ 25 mm (gram force per millimeter). At the same time, the first protective film may be flush with the adhesive layer 1042, which can further avoid the first protective layer and the adhesive layer 1042 from separation.

Referring to FIG. 9, a second protective film is formed on the side, away from the base 1041, of the protective layer 1044 of the bridge circuit structure 104. The second protective film can increase the stiffness of the bridge circuit structure 104 and reduce the deformation of the bridge circuit structure 104 when the bridge circuit structure 104 is bonded to the substrate 101.

In the embodiments of the present application, the side surface of the bridge circuit structure 104 close to the first side surface 101c of the substrate 101, the side surface of the first protective film, and the side surface of the second protective film are formed by a single cutting process. The side surface of the bridge circuit structure 104 close to the first side surface 101c of the substrate 101 further includes the side surface of the adhesive layer 1042 in addition to the second side surface 1041c of the base 1041.

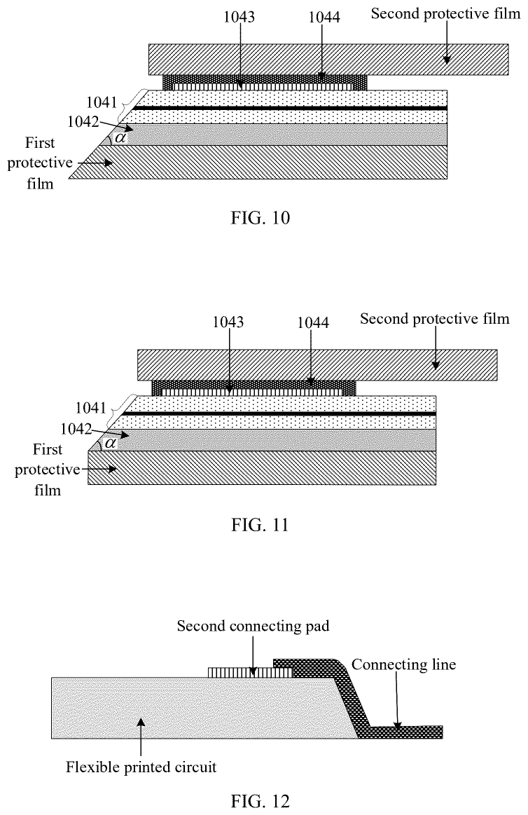

Optionally, referring to FIG. 9, the side surface of the bridge circuit structure 104 close to the first side surface 101c of the substrate 101, the side surface of the first protective film, and the side surface of the second protective film are perpendicular to the bearing surface of the base 1041. Alternatively, referring to FIG. 10 and FIG. 11, an angle a between the side surface of the bridge circuit structure 104 close to the first side surface 101c of the substrate 101 and the third surface 1041a of the base 1041 is an acute angle, and the orthographic projection of the fourth surface 1041b of the base 1041 on the third surface 1041a of the base 1041 is within the third surface 1041a of the base 1041.

Referring to FIG. 10, when the side surface of the bridge circuit structure 104 close to the first side surface 101c of the substrate 101 is formed by cutting, only the side surface of the bridge circuit structure 104 close to the first side surface 101c of the substrate 101 is cut to be an inclined surface, such that the angle is be an acute angle. Alternatively, referring to FIG. 11, when the side surface of the bridge circuit structure 104 close to the first side surface 101c of the substrate 101 is formed by cutting, the side surface of the bridge circuit structure 104 close to the first side surface 101c of the substrate 101 and the side surface of the first protective film are both cut to be inclined surfaces, such that the angle is be an acute angle. Optionally, the angle between the second side surface 1041c and the third surface 1041a ranges from 30° to 75°.

In the embodiments of the present application, by making the side surface of the bridge circuit structure 104 close to the first side surface 101c of the substrate 101 be an inclined surface, the second end of the connecting line 103 can easily climb the inclined surface, thereby improving the yield of the connecting line 103.

Additionally, the base 1041 includes a flexible film layer. For example, the base 1041 is a single-layer polyimide (PI) film layer. Alternatively, as shown in FIG. 2, the base 1041 includes a first flexible film layer, a buffer layer, and a second flexible film layer stacked in sequence. For example, the base 1041 is a sandwich structure of a polyimide film layer, a buffer layer, and a polyimide film layer, denoted as PI/barrier/PI.

Regardless of whether the base 1041 is a single-layer polyimide film layer or a PI/barrier/PI sandwich structure, the thickness of the base 1041 ranges from 10 μm to 30 μm. that is, the thickness of the base 1041 is greater than or equal to 10 μm and less than or equal to 30 μm. Additionally, since the material of the base 1041 includes PI, the bridge circuit structure 104 is also referred to as a PI bridge.

With reference to FIG. 12 to FIG. 15, in the embodiments of the present application, the base 1041 of the bridge circuit structure 104 is thinner than an ordinary FPC. Therefore, in the embodiments of the present application, by providing the bridge circuit structure 104, the connecting lines 103 can climb more easily, the defects of the connecting lines 103 such as breakage will not happen, and the production yield is high.

Referring to FIG. 15, the functional backplane 10 further includes a cushion layer structure 106 disposed on the side, close to the first side surface 101c of the substrate 101, of the second side surface 1041c of the base 1041. The angle between the surface of the cushion layer structure 106 close to the first side surface 101c of the substrate 101 and the third surface 1041a of the base 1041 is smaller than the angle between the second side surface 1041c and the third surface 1041a of the base 1041. That is, after the bridge circuit structure 104 is bonded to the second surface 101b of the substrate 101, the second end of the connecting line 103 needs to climb to be connected to the bridge line on the base 1041.

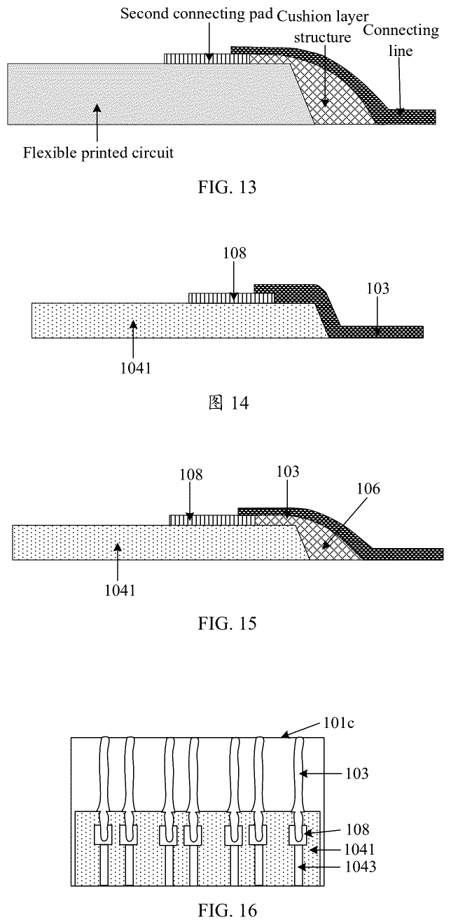

The FPC in FIG. 12 is thicker, and has a bigger segment difference in the case that no cushion layer structure is provided, and the climbing yield of the connecting line is lower. The base 1041 in FIG. 14 is thinner, and has a smaller segment difference in the case that no cushion layer structure is provided, and the climbing yield of the connecting line is higher. If the above embodiments are improved, for example, the cushion layer structure 106 is added to the end portions, provided with the second connecting pad 108, of the FPC and the base 1041 respectively as shown in FIG. 13 and FIG. 15, the climbing yield of the connecting line 103 can be improved.

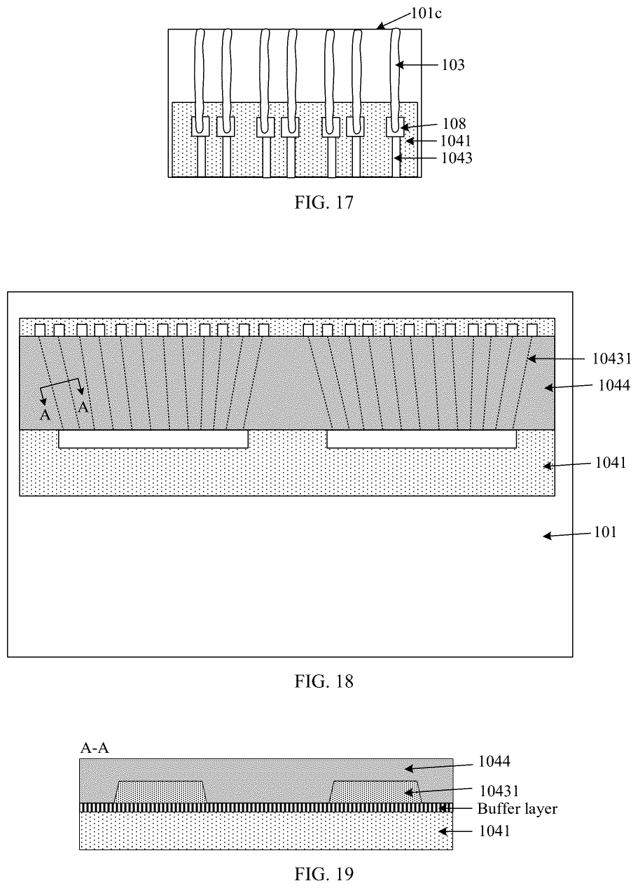

Furthermore, referring to FIG. 16, in the case that the cushion layer structure 106 is not provided, the connecting line 103 has a poor line uniformity, the connecting line 103 piles up at the end portion of the base 1041 close to the first side surface 101c (the line width is obviously increased at this position), and two adjacent connecting lines 103 are easily short-circuited here. Referring to FIG. 17, in the case that the cushion layer structure 106 is provided, the connecting line 103 has a better line uniformity, and the connecting line 103 has only a slight change in line width at the end portion of the base 1041 close to the first side surface 101c.

That is, for the climbing design, the slope can be reduced by providing the cushion layer structure 106, such that the climbing of the second end of the connecting line 103 is gentler, thereby further improving the yield of the connecting line 103.

In the embodiments of the present application, referring to FIG. 1, FIG. 3, and FIG. 4, the functional backplane 10 further includes a first connecting pad 107 and a second connecting pad 108. The first connecting pad 107 is disposed on the first surface 101a of the substrate 101 and is configured to connect the first end of the connecting line 103 to the electronic component 102. The second connecting pad 108 is disposed on the fourth surface 1041b of the base 1041 and is configured to connect the second end of the connecting line 103 to the first end of the bridge line.

Referring to FIG. 15, the cushion layer structure 106 can not only be disposed on the second side surface 1041c of the base 1041 to facilitate the climb of the connecting line 103 on the second side surface 1041c of the base 1041, but also be disposed on the side surface of the second connecting pad 108 to facilitate climb of the connecting line 103 on the side surface of the second connecting pad 108, thereby achieve signal transmission with the second connecting pad 108. That is, the start position and the end position of the cushion layer structure 106 are located on two sides of the second side surface 1041c of the base 1041, and the climbing effect of the connecting line 103 can be improved by providing the cushion layer structure 106.

Optionally, the plurality of first connecting pads 107 of the functional backplane 10 are spaced apart from each other in the second direction Y, and each first connecting pad 107 is connected to a corresponding connecting line 103. Moreover, the plurality of second connecting pads 108 of the functional backplane 10 are spaced apart from each other in the second direction Y, and each second connecting pad 108 is connected to a corresponding connecting line 103 and a corresponding bridge line.

Optionally, the distance A between the second connecting pad 108 and the second side surface 1041c of the base 1041 ranges from 100 μm to 0.5 mm. The distance A ranging from 100 μm to 0.5 mm refers to that the distance A is greater than or equal to 100 μm and less than or equal to 0.5 mm, i.e., 100 μm≤A≤0.5 mm.

In the case that the distance A is less than 100 μm, the bridge line in the line layer 1043 will be cut when the side surface of the bridge circuit structure 104 is formed by cutting, which affects the signal transmission. In the case that the distance A is greater than 0.5 mm, the printed path of the connecting line 103 on the base 1041 is too long, which affects the resistance of the connecting line 103.

In the embodiments of the present application, the distance B between the second end of the bridge line and the third side surface 1041d of the base 1041 (the third side surface 1041d is a surface of the base 1041 that is farthest from the first side surface 101c) ranges from 0 mm to 20 mm. The distance B ranging from 0 mm to 20 mm refers to that the distance B is greater than or equal to 0 mm and less than or equal to 20 mm, i.e., 0 mm<B≤20 mm. It will be appreciated that the distance B being equal to 0 refers to that the second end of the bridge line is located at an intersection line between the fourth surface 1041b and the third side surface 1041d of the base 1041.

Optionally, the distance C between the side of the second protective film close to the third side surface 1041d of the base 1041 and the third side surface 1041d of the base 1041 ranges from 3 mm to 10 mm. The distance C ranging from 3 mm to 10 mm refers to that the distance C is greater than or equal to 3 mm and less than or equal to 10 mm, i.e., 3 mm≤C≤10 mm. The second protective film is set to extend over the third side surface 1041d of the base 1041, which can facilitate the removal of the second protective film later.

Optionally, the length E of the base 1041 along the second direction Y is related to the length of the product, and the length F of the base 1041 along the first direction X is related to the width of the product. Exemplarily, the length E of the base 1041 along the second direction Y satisfies: 60 mm≤E≤200 mm, and the length F of the base 1041 along the first direction X satisfies: 15 mm≤F≤60 mm.

In the embodiments of the present application, the bridge line includes a bridge portion between the first end and the second end thereof, and the bridge portion is a bridge line formed on the base 1041 and functions to transmit the driving signal received from the second end to the first end.

In an optional implementation, the protective layer 1044 is made of an insulative material, and the protective layer 1044 functions to isolate water and oxygen, thereby avoiding the product from being eroded by water and oxygen. In this case, referring to FIG. 18 and FIG. 19, the protective layer 1044 is of a whole layer structure, and the orthographic projection of the protective layer 1044 on the base 1041 covers the orthographic projection of the bridge portion on the base 1041, and thus the protective layer 1044 can protect the bridge portion. Moreover, since the first end of the bridge line is connected to the second end of the connecting line 103 by the second connecting pad 108, and the second end of the bridge line is connected to the external circuit structure, the first end and the second end of the bridge line cannot be covered by the insulative material, otherwise the signal conduction cannot be achieved. That is, the orthographic projection of the protective layer 1044 on the base 1041 exposes the orthographic projections of the first end and the second end of the bridge line on the base 1041.

Optionally, the insulating material is made of silicon nitride (SiNx), silicon oxide (SiOx), or a mixture of SiNx and SiOx.

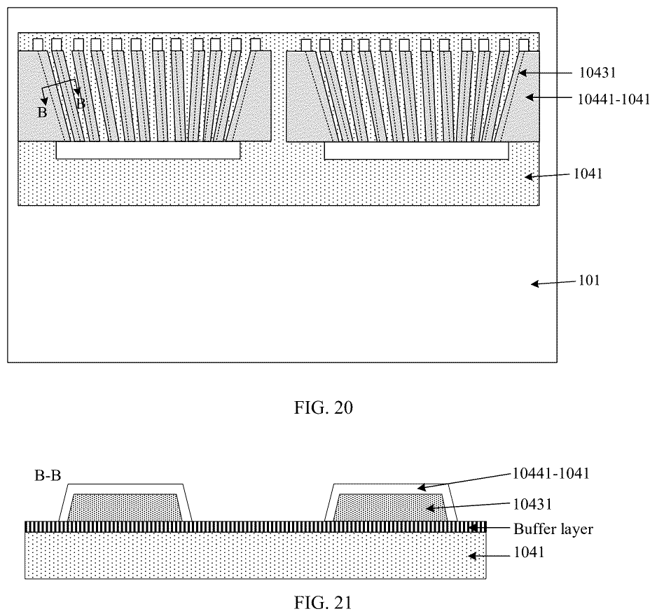

In another optional implementation, the protective layer 1044 is made of an electrically conductive material, e.g., indium tin oxide (ITO). In this case, in order to avoid the plurality of bridge lines from being short-circuited due to the electrically conductive protective layer 1044, referring to FIG. 20 and FIG. 21, the protective layer 1044 includes a plurality of protective patterns 10441 spaced apart from each other and corresponding to the plurality of bridge lines, and the orthographic projection of each protective pattern 10441 on the base 1041 covers the orthographic projection of the corresponding bridge line 10431 on the base 1041. Moreover, since the protective layer 1044 is made of an electrically conductive material, the signal transmission will not be affected even if the protective layer 1044 covers the first end and the second end of the bridge line 10431.

Additionally, referring to FIG. 19 and FIG. 21, the bridge circuit structure 104 further includes a buffer layer disposed between the base 1041 and the line layer 1043.

Referring to FIG. 1 and FIG. 3, the functional backplane 10 further includes an encapsulation layer 109 disposed on the side of the plurality of electronic components 102 away from the substrate 101, and the encapsulation layer 109 is configured to encapsulate the plurality of electronic components 102 to avoid the electronic components 102 from being eroded by water and oxygen.

In summary, the embodiments of the present application provide a functional backplane, including a substrate, a plurality of electronic components, a plurality of connecting lines, and a bridge circuit structure. The bridge circuit structure includes a base, an adhesive layer disposed on the third surface of the base, and a line layer and a protective layer that are disposed on the fourth surface of the base. Each bridge line in the line layer is connected to the corresponding connecting line, thereby transmitting the driving signal provided by the external circuit structure to which the bridge line is connected to the electronic component via the connecting line. According to the solution in the embodiments of the present application, the widths occupied by the end portions of all bridge lines are limited to a smaller size range, and thus there is no need to bond a larger number of flexible printed circuits for connection to the external circuit structure. Therefore, the flexibility is higher.

The terms used in the embodiments of the present application are merely intended for explaining the embodiments of the present application and are not intended to limit the present application. Unless otherwise defined, the technical terms or scientific terms used in the embodiments of the present application shall be taken to mean the ordinary meaning understood by those of ordinary skill in the art to which the present application belongs.

The terms used in the embodiments of the present application are merely intended for explaining the embodiments of the present application and are not intended to limit the present application. Unless otherwise defined, the technical terms or scientific terms used in the embodiments of the present application shall be taken to mean the ordinary meaning understood by those of ordinary skill in the art to which the present application belongs. The terms “first,” “second,” “third,” and similar terms used in the description and claims of the present application do not denote any order, quantity, or importance, but rather are merely used to distinguish between different components. Similarly, the singular forms “an,” “a,” and “the” are not intended to limit the quantity but include both singular and plural referents. The term “include” or “comprise” and similar terms are intended to mean that the element or object before “include” or “comprise” covers the elements or objects or equivalents listed after “include” or “comprise,” without excluding other elements or objects. The term “connection” or “connected” and similar terms are not limited to physical or mechanical connection, and may include electrical connection, either directly or indirectly. The terms “on,” “under,” “left,” “right,” and the like only indicate the relative positional relationship, and when the absolute position of a described object changes, the relative positional relationship may also change accordingly.

Described above are merely embodiments of the present application, and are not intended to limit the present application. Within the spirit and principles of the present application, any modifications, equivalent substitutions, improvements, and the like are within the protection scope of the present application.

1. A functional backplane, comprising:
a substrate comprising a first surface and a second surface which are opposite to each other in a thickness direction of the substrate;
a plurality of electronic components disposed on the first surface of the substrate;
a plurality of connecting lines, wherein a first end of each of the connecting lines is disposed on the first surface of the substrate and connected to the electronic component, and a second end of each of the connecting lines is disposed on the second surface of the substrate; and
a bridge circuit structure comprising a base, an adhesive layer, a line layer, and a protective layer; wherein the base has a third surface and a fourth surface which are opposite to each other in a thickness direction of the base; the adhesive layer is disposed on the third surface of the base, and the adhesive layer is configured to bond the base to the second surface of the substrate; the line layer is disposed on the fourth surface of the base, the line layer comprises a plurality of bridge lines corresponding to the plurality of connecting lines, a first end of each of the bridge lines is connected to a second end of a corresponding connecting line, and a second end of each of the bridge lines is configured to be connected with an external circuit structure, so that driving signals provided by the external circuit structure are transmitted to the electronic component via the bridge lines and the connecting lines; and the protective layer is disposed on a side of the line layer away from the base.

2. The functional backplane according to claim 1, wherein
the second surface of the substrate is provided with at least one first alignment mark configured for structural alignment; and
the base is provided with at least one first alignment opening corresponding to the at least one first alignment mark, wherein an orthographic projection of the first alignment opening on the substrate covers a corresponding first alignment mark, and the orthographic projection of the first alignment opening on the substrate is not overlapped with orthographic projections of the plurality of bridge lines on the substrate.

3. The functional backplane according to claim 2, wherein
a distance h1 between an edge of the first alignment mark and an edge of an orthographic projection of a corresponding first alignment opening on the substrate ranges from 20 μm to 1 mm; and
a center of the first alignment mark is in a middle region of the orthographic projection of the corresponding first alignment opening on the substrate.

4. The functional backplane according to claim 3, wherein the orthographic projection of the first alignment opening on the substrate is in the shape of one of a square, an ellipse, a circle and a regular polygon.

5. The functional backplane according to claim 1, wherein
a second surface of the base is provided with at least one second alignment mark configured for structural alignment;
the adhesive layer is provided with at least one second alignment opening corresponding to the at least one second alignment mark, wherein an orthographic projection of the second alignment mark on the substrate is within an orthographic projection of a corresponding second alignment opening on the substrate.

6. The functional backplane according to claim 1, wherein a plurality of strip-shaped venting slots is formed in the adhesive layer; wherein the plurality of venting slots at least comprises a first slot extending along a first direction and a second slot extending along a second direction, wherein the first direction is an extension direction of a portion of the connecting line disposed on the second surface, and the second direction is intersected with the first direction; and
an orthographic projection of the first slot on the substrate and an orthographic projection of the second slot on the substrate are on a side, away from the first end of each of the bridge lines, of the second end of each of the bridge lines.

7. The functional backplane according to claim 6, wherein the plurality of venting slots comprises a plurality of first slots and one second slot, and the second direction is perpendicular to the first direction; and
the plurality of first slots is further away from the bridge lines than the second slot, the plurality of the first slots is spaced apart from each other in the second direction, and a first end of each of the first slots is in communication with the second slot.

8. The functional backplane according to claim 1, wherein a distance between a first side surface of the substrate and a second side surface of the base ranges from 0.5 mm to 5 mm; wherein
the first side surface of the substrate is a side surface of the substrate that is closest to a connecting portion between the first end of the connecting line and the second end of the connecting line, and the second side surface of the base is a side surface of the base that is closest to the first side surface of the substrate.

9. The functional backplane according to claim 8, wherein an angle between the second side surface and the third surface of the base is an acute angle, and an orthographic projection of the fourth surface of the base on the third surface of the base is within the third surface of the base.

10. The functional backplane according to claim 9, wherein the angle between the second side surface and the third surface ranges from 30° to 75°.

11. The functional backplane according to claim 8, further comprising: a cushion layer structure disposed on a side, close to the first side surface of the substrate, of the second side surface of the base; wherein
an angle between a surface of the cushion layer structure close to the first side surface of the substrate and the third surface of the base is less than an angle between the second side surface of the base and the third surface of the base.

12. The functional backplane according to claim 8, further comprising: a first connecting pad and a second connecting pad; wherein
the first connecting pad is disposed on the first surface of the substrate and is configured to connect the first end of the connecting line to the electronic component; and
the second connecting pad is disposed on the fourth surface of the base and is configured to connect the second end of the connecting line to the first end of the bridge line;
wherein a distance h3 between the second connecting pad and the second side surface of the base ranges from 100 μm to 0.5 mm.

13. The functional backplane according to claim 1, wherein the bridge line comprises a bridge portion between the first end and the second end; wherein
the protective layer is made of an insulative material, the protective layer is of a whole layer structure, and an orthographic projection of the protective layer on the base covers an orthographic projection of the bridge portion on the base and exposes orthographic projections of the first end and the second end of each of the bridges line on the base.

14. The functional backplane according to claim 1, wherein
the base comprises one of a flexible film layer and a combination of a first flexible film layer, a buffer layer, and a second flexible film layer stacked in sequence.

15. A light-emitting device, comprising: a power supply assembly and a functional backplane; wherein
the power supply assembly is configured to supply power to the functional backplane, and the functional backplane comprises:
a substrate comprising a first surface and a second surface which are opposite to each other in a thickness direction of the substrate;
a plurality of electronic components disposed on the first surface of the substrate;
a plurality of connecting lines, wherein a first end of each of the connecting lines is disposed on the first surface of the substrate and connected to the electronic component, and a second end of each of the connecting lines is disposed on the second surface of the substrate; and
a bridge circuit structure comprising a base, an adhesive layer, a line layer, and a protective layer; wherein the base has a third surface and a fourth surface which are opposite to each other in a thickness direction of the base; the adhesive layer is disposed on the third surface of the base, and the adhesive layer is configured to bond the base to the second surface of the substrate; the line layer is disposed on the fourth surface of the base, the line layer comprises a plurality of bridge lines corresponding to the plurality of connecting lines, a first end of each of the bridge lines is connected to a second end of a corresponding connecting line, and a second end of each of the bridge lines is configured to be connected with an external circuit structure, so that driving signals provided by the external circuit structure are transmitted to the electronic component via the bridge lines and the connecting lines; and the protective layer is disposed on a side of the line layer away from the base.

16. The functional backplane according to claim 1, wherein the bridge line comprises a bridge portion between the first end and the second end; wherein
the protective layer is made of an electrically conductive material, and the protective layer comprises a plurality of protective patterns spaced apart from each other and corresponding to the plurality of bridge lines, wherein an orthographic projection of each of the plurality of protective patterns on the base covers an orthographic projection of a corresponding bridge line on the base.

17. The light-emitting device according to claim 15, wherein
the second surface of the substrate is provided with at least one first alignment mark configured for structural alignment; and
the base is provided with at least one first alignment opening corresponding to the at least one first alignment mark, wherein an orthographic projection of the first alignment opening on the substrate covers a corresponding first alignment mark, and the orthographic projection of the first alignment opening on the substrate is not overlapped with orthographic projections of the plurality of bridge lines on the substrate.

18. The light-emitting device according to claim 17, wherein a distance h1 between an edge of the first alignment mark and an edge of an orthographic projection of a corresponding first alignment opening on the substrate ranges from 20 μm to 1 mm; and
a center of the first alignment mark is in a middle region of the orthographic projection of the corresponding first alignment opening on the substrate.

19. The light-emitting device according to claim 18, wherein the orthographic projection of the first alignment opening on the substrate is in the shape of one of a square, an ellipse, a circle and a regular polygon.

20. light-emitting device according to claim 15, wherein
a second surface of the base is provided with at least one second alignment mark configured for structural alignment;
the adhesive layer is provided with at least one second alignment opening corresponding to the at least one second alignment mark, wherein an orthographic projection of the second alignment mark on the substrate is within an orthographic projection of a corresponding second alignment opening on the substrate.
